(19) United States
(12) Patent Application Publication
(10) Pub. No.: US 2022/0057339 A1
(43) Pub. Date: Feb. 24, 2022

(54) METHOD FOR ANALYSING THE SPACE ENVIRONMENT AND ASSOCIATED DEVICE

(71) Applicants: CENTRE NATIONAL DE LA RECHERCHE SCIENTIFIQUE, Paris (FR); UNIVERSITE GRENOBLE ALPES, Saint Martin d'Heres (FR)

(72) Inventors: Jean LILENSTEN, Quaix en Chartreuse (FR); Sylvain ROCHAT, Poisat (FR)

(21) Appl. No.: 17/413,895

(22) PCT Filed: Dec. 18, 2019
(86) PCT No.: PCT/EP2019/085900

§ 371 Date: Jun. 14, 2021

(30) Foreign Application Priority Data
Dec. 19, 2018 (FR) 1873378

(51) Int. Cl. G01N 22/00; G01J 3/02; G01J 4/04

(52) U.S. Cl. CPC G01N 22/00; G01J 4/04; G01J 3/0224

(57) ABSTRACT

A method for analysing radiation emitted by the upper atmosphere, including the steps of collecting a beam coming from a direction (h, A) of the atmosphere, polarising the collected beam, selecting at least one frequency range of the collected beam and measuring an intensity of the at least one frequency range of the collected and polarised beam (I(θ,t)) according to the angle θ(t). The method includes the step of determining, from the values of I(θ,t) collected on a rotation of at least Π/2 radians of the variable angle polariser:—at least one physical and/or chemical and/or electromagnetic parameter of the upper atmosphere, and/or a variation of at least one physical and/or chemical and/or electromagnetic parameter of the upper atmosphere, and/or—a probability of malfunction and/or degradation of networks and/or electrical and/or electronic equipment and/or systems and/or devices.

### TECHNICAL FIELD

The present invention relates to the field of space meteorology.

The present invention relates in particular to the analysis and monitoring of the Earth's space environment in order to measure and forecast phenomena or incidents disturbing the Earth's space environment and in particular the upper atmosphere. These phenomena or incidents can be, for example, intrinsic variations of the Earth's magnetic field and/or of electric fields present in the upper atmosphere and/or of the ionosphere currents. External perturbations such as, for example, solar winds can also disturb the Earth's space environment.

These perturbations have a direct impact on satellites, networks, installations and electrical or electronic systems and affect the services and functionalities implemented thereby. This is manifested, for example, through interference with telecommunications, loss of several tens of metres' accuracy of location and positioning services (GPS) or also the interruption of guided directional drilling based on measuring the internal magnetic field.

### STATE OF THE PRIOR ART

A limited number of instruments are known in the state of the art for observation of the space environment from the ground. Magnetometers exist that measure the variations of the external magnetic field projected at ground level. Interferometers are also known for measuring the wind at altitudes of the order of 200 km. There are also ionospheric recorders that measure the electronic profile of certain layers of the atmosphere comprised between 80 and 200 km. Coherent or incoherent scatter radars are available, in a much higher price range, requiring international collaboration.

Geodesic stations are also known, equipped with receivers making it possible to measure the total electronic content of the ionosphere.

A purpose of the invention is in particular to:
forecast perturbations of satellite or terrestrial telecommunications, and/or
correct the effects produced by perturbations of the upper atmosphere on satellites, networks, installations and electrical or electronic systems, and/or
anticipate degradation caused to satellites, networks, installations and electrical or electronic systems, and/or
monitor the Earth's space environment, and/or
measure, from the Earth's surface, parameters of the upper atmosphere, such as, for example, variations of the Earth's magnetic field.

### DESCRIPTION OF THE INVENTION

To this end, there is proposed a method for analysing radiation emitted by the upper atmosphere comprising the steps consisting of:
collecting a beam originating from a direction (h, A) of the atmosphere,
polarizing the collected beam by selecting a direction of polarization of the collected beam for each value of an angle θ(t) varying over time t, the angle θ(t) being formed between an axis of polarization of a variable angle polarizer and a reference direction,
selecting at least one frequency range of the collected beam,
measuring an intensity of the at least one frequency range of the collected and polarized, as a function of the angle θ(t), beam (I(θ,t)),
determining, from values of I(θ,t) collected over a rotation of at least π/2 radians of the variable angle polarizer (preferably only from values of I(θ,t) collected over a rotation of at least π/2 radians of the variable angle polarizer):
   at least one physical and/or chemical and/or electromagnetic parameter of the upper atmosphere, and/or a variation of at least one physical and/or chemical and/or electromagnetic parameter of the upper atmosphere, and/or
   a probability of malfunction and/or degradation of networks and/or installations and/or systems and/or electrical and/or electronic devices.

By “upper atmosphere” (UA) is meant the portion of the Earth's space environment comprising, at least, the ionosphere and the thermosphere. According to the invention, the upper atmosphere corresponds to the Earth's atmospheric environment situated at an altitude greater than 50 km and/or less than 400 km with respect to the Earth's surface.

The beam originating from the direction (h, A) of the atmosphere is collected according to a defined solid angle. The solid angle can be comprised between 1 and 10°.

A radiation emitted by the upper atmosphere (RUA) corresponds to an emission that is discrete, for example a ray, or of limited wavelength, for example a band, capable of being extended over a range of wavelengths, of a chemical element and/or molecule present in, and/or constituting, the upper atmosphere (UA). The RUA emission can be defined as being emitted during the passage of a chemical element and/or molecule constituting the UA from an excited state to a more stable state. The inventors have demonstrated that the angle of polarization of the radiation that is emitted is linked to the magnetic field lines. The solar winds thus directly influence the emissions in that the collision frequency between the electrons and the chemical elements and/or molecules constituting the UA increase when the intensity of the solar winds increases.

The selected frequency range of the collected beam is such that the collected beam selected comprises at least one RUA.

The at least one determined physical and/or chemical and/or electromagnetic parameter of the upper atmosphere can comprise:
a concentration and/or a temperature and/or a composition and/or a velocity of at least one of the components of the upper atmosphere, and/or
a value of the Earth's magnetic field, and/or
an ionospheric current, and/or
a value of the electric field, and/or
an angle of polarization (AoLP) of a radiation emitted by the upper atmosphere in a manner polarized at a wavelength comprised within the selected frequency range of the collected beam, and/or
a degree of polarization (DoLP), before collection, of the collected beam.

The electric field can be a local field.

By “Earth's magnetic field” is meant the Earth's external magnetic field.

The variation of at least one physical and/or chemical and/or electromagnetic parameter of the determined upper atmosphere can comprise varying:
a concentration and/or a temperature and/or a composition and/or a velocity of at least one of the components of the upper atmosphere, and/or
a value of the Earth's magnetic field, and/or
an ionospheric current, and/or
a value of the electric field, and/or
an angle of polarization (AoLP) of a radiation emitted by the upper atmosphere in a manner polarized at a wavelength comprised within the selected frequency range of the collected beam, and/or
a degree of polarization (DoLP), before collection, of the collected beam.

The determination step can be carried out:
by using, over a time interval corresponding to a rotation of at least π/2 radians of the variable angle polarizer, I(θ,t) and the product of I(θ,t) multiplied by sine (2θ(t)) and/or cos(2θ(t)), and/or
by calculating a relationship between:
   an intensity, at twice a rotation frequency of the polarizer, of a Fourier transform of I(θ,t), and
   an intensity, at zero frequency, of a Fourier transform of the at least one frequency range of an unpolarized collected beam originating from the direction (h, A) of the atmosphere, and/or
implementing the steps consisting of:
   applying a band-pass filter at I(θ,t),
   adjusting the filtered value of I(θ,t) by a cos².

A portion of the collected beam can be the unpolarized collected beam originating from the direction (h, A) of the atmosphere and another portion of the collected beam can be the polarized collected beam originating from the direction (h, A) of the atmosphere.

The unpolarized collected beam originating from the direction (h, A) of the atmosphere can be a beam collected separately from the polarized collected beam originating from the direction (h, A) of the atmosphere.

The band-pass filter can comprise a high-pass filter and/or a low-pass filter.

The probability of malfunction and/or degradation can be determined from the at least one determined physical and/or chemical and/or electromagnetic parameter of the determined upper atmosphere, and/or from the variation of at least one physical and/or chemical and/or electromagnetic parameter of the determined upper atmosphere.

One or more step(s) of the method can be implemented, concomitantly or successively, for several frequency ranges of the collected beam.

The one or more step(s) of the method that are implemented, concomitantly or successively, for several frequency ranges of the collected beam are preferably, among others, the selection and determination steps.

The at least one selected frequency range of the collected beam can be different from at least one other selected frequency range of the collected beam or from another collected beam.

The selection and determination steps can be implemented, concomitantly or successively, for several frequency ranges of the collected beam, or of collected beams, each of the selected frequency ranges being different from another of the selected frequency ranges.

The collection and determination steps can be implemented, concomitantly or successively, for several collected beams originating from different directions of the atmosphere.

The speed of variation of the angle θ(t) during the polarization step can be variable over time.

The speed of variation of the angle θ(t) can adopt a value of zero. The speed of variation of the angle θ(t) can adopt a value of zero at a given moment. The variation of the angle over time can be discontinuous.

The speed of variation of the angle θ(t) during the polarization step can be constant over time.

The at least one frequency range of the collected beam selected during the selection step can be comprised between 1.10³ and 1.10⁷ GHz.

The method can comprise a step of compensation of the at least one frequency range of the collected beam selected by modulation of an angle φ formed between a direction of propagation of the collected beam and an optical element used for the step of selecting the at least one frequency range of the collected beam.

A device is also proposed for analysis of radiation emitted by the upper atmosphere comprising at least one detection path, said at least one detection path comprising:
a collector arranged for collecting a beam originating from a direction of the atmosphere (h, A),
a variable angle polarizer arranged for selecting a direction of polarization of the collected beam for each value of an angle θ(t) formed between an axis of polarization of the variable angle polarizer and a reference direction, the angle θ(t) varying over time t,
an optical element arranged for selecting at least one frequency range of the collected beam,
a photo-detector arranged for measuring the intensity of the at least one frequency range of the collected and polarized, as a function of the angle θ(t), beam (I(θ,t));
said device comprising a processing unit arranged and/or configured and/or programmed to determine, from values of I(θ,t) collected over a rotation of at least π/2 radians of the variable angle polarizer:
   at least one physical and/or chemical and/or electromagnetic parameter, and/or a variation of at least one physical and/or chemical and/or electromagnetic parameter of the upper atmosphere, and/or
   a probability of malfunction and/or degradation of networks and/or installations and/or systems and/or electrical and/or electronic devices.

Preferably, the device comprises a single detection path or several detection paths, the single path or each of the paths from the several detection paths comprising a collector, a variable angle polarizer and an optical element.

By “detection path” is meant any optical device, or part of an optical device, within which an optical beam is able to propagate and is intended to be detected.

Preferably, the device is arranged in order to implement the method according to the invention.

The photo-detector can be of the single-pixel or pixel array type.

The at least one determined physical and/or chemical and/or electromagnetic parameter of the upper atmosphere can comprise:
a concentration and/or a temperature and/or a composition and/or a velocity of at least one of the components of the upper atmosphere, and/or
a value of the Earth's magnetic field, and/or
an ionospheric current, and/or
a value of the electric field, and/or
an angle of polarization (AoLP) of a radiation emitted by the upper atmosphere in a manner polarized at a wavelength comprised within the selected frequency range of the collected beam, and/or
a degree of polarization (DoLP), before collection, of the collected beam.

The variation of at least one physical and/or chemical and/or electromagnetic parameter of the determined upper atmosphere can comprise varying:
a concentration and/or a temperature and/or a composition and/or a velocity of at least one of the components of the upper atmosphere, and/or
a value of the Earth's magnetic field, and/or
an ionospheric current, and/or
a value of the electric field, and/or
an angle of polarization (AoLP) of a radiation emitted by the upper atmosphere in a manner polarized at a wavelength comprised within the selected frequency range of the collected beam, and/or
a degree of polarization (DoLP), before collection, of the collected beam.

The processing unit can be arranged and/or configured and/or programmed to determine the at least one parameter and/or the variation of at least one parameter and/or the probability of malfunction and/or degradation:
by using, over a time interval corresponding to a rotation of at least π/2 radians of the variable angle polarizer, I(θ,t) and the product of I(θ,t) multiplied by sine (2θ(t)) and/or cos(2θ(t)), and/or
by calculating a relationship between:
   an intensity, at twice the rotation frequency of the polarizer, of a Fourier transform of I(θ,t), and
   an intensity, at zero frequency, of a Fourier transform of the at least one frequency range of an unpolarized collected beam originating from the direction (h, A) of the atmosphere, and/or
implementing the steps consisting of:
   applying a band-pass filter at I(θ,t),
   adjusting the filtered value of I(θ,t) by a cos².

The processing unit can be arranged and/or configured and/or programmed to determine the probability of malfunction and/or degradation from the at least one parameter and/or from the variation of at least one parameter.

The polarizer can be arranged to be rotated at a speed of rotation that is variable over time.

The polarizer can be arranged so that the speed of variation of the angle θ(t) can adopt a value of zero. The polarizer can be arranged so that the speed of variation of the angle θ(t) can adopt a value of zero at a given moment. The polarizer can be arranged so that the variation of the angle over time is discontinuous.

The polarizer can be arranged so that the speed of variation of the angle θ(t) is constant over time.

The optical element can be arranged to select the at least one frequency range of the collected beam within a range of frequencies comprised between 1.10³ and 1.10⁷ GHz.

The optical element can be arranged for selecting several frequency ranges of the collected beam.

The optical element can be arranged for selecting several different frequency ranges of the collected beam.

The optical element can be an optical filter.

The optical element can be arranged to disperse light. The optical element can be a prism or a diffraction grating.

The optical element can be arranged so that an angle φ formed between a direction of propagation of the collected beam in the path and the optical element is capable of being modulated so as to modify the at least one frequency range of the collected beam, the frequency range being selected by the optical element.

This characteristic can make it possible to overcome the shifts, produced by a temperature variation, of the at least one frequency range selected by the optical element by modifying the angle φ so as to compensate for the shift caused by the temperature variation.

This characteristic can also make it possible to modify at will the at least one frequency range selected by the optical element, by modifying the angle φ.

The device can comprise several detection paths and:
each of the detection paths can comprise an optical element, and/or
a detection path can be arranged for collecting a beam originating from a direction of the atmosphere different from:
   a direction of the atmosphere from which a beam collected by another detection path originates, or
   directions of the atmosphere from which beams collected by other detection paths originate, or
   all of the directions of the atmosphere from which the beams collected by the other detection paths originate.

When the device comprises several detection paths, the collector and/or the photo-detector and/or the polarizer and/or the optical element can be common to all the paths. Preferably, when the photo-detector is common to all the paths, each of the paths comprises a polarizer.

An optical element of a detection path can be arranged for selecting at least one frequency range of the collected beam different from at least one other frequency range of the collected beam, or from another collected beam, the frequency range being selected by an optical element of another detection path.

The device can comprise one or more mechanism(s) for movement arranged for modifying an orientation and/or an elevation:
of a detection path independently of an orientation and/or an elevation of another detection path, or
of several detection paths independently of an orientation and/or an elevation of one or more other detection path(s), or
of all of the detection paths simultaneously.

### DESCRIPTION OF THE FIGURES

Other advantages and features of the invention will become apparent on reading the detailed description of implementations and embodiments that are in no way limitative, and from the following attached figures:

FIG. 1 is a diagrammatic representation of the process of emission of the RUAs emitted in the UA as a function of altitude and of the collection of a beam originating from a given direction of the atmosphere and comprising RUAs,

FIG. 2 shows four sets of measurements according to the invention, carried out in the auroral region during an aurora borealis, each set relating to a different RUA,

FIG. 3 shows four sets of measurements according to the invention, carried out at mid-latitude, each set relating to a different RUA,

FIG. 4 shows a set of measurements according to the invention of a given RUA, carried out at mid-latitude for different azimuths,

FIG. 5 is a diagrammatic representation of a detection path of an embodiment of device 1 according to the invention for analysis of RUA,

FIG. 6 is a diagrammatic representation of the device 1 for analysis of RUA comprising a detection path,

FIG. 7 is a diagrammatic representation of a variant of the device 1 for analysis of RUA comprising two detection paths,

FIG. 8 is a diagrammatic representation of a variant of the device 1 for analysis of RUA comprising four detection paths.

### DESCRIPTION OF THE EMBODIMENTS

As the embodiments described hereinafter are in no way !imitative, variants of the invention can in particular be considered comprising only a selection of the characteristics described, in isolation from the other characteristics described (even if this selection is isolated within a phrase comprising these other characteristics), if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

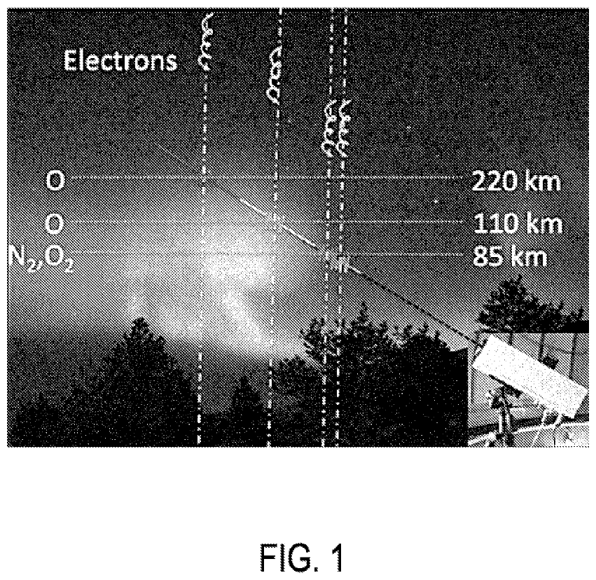

With reference to FIGS. 1 to 8, a method for analysing radiation emitted by the upper atmosphere is described in a first embodiment. The method comprises a step of collecting a beam originating from a direction of the atmosphere (h, A). The collection step is carried out by means of a collector 3. The direction of the atmosphere (h, A) can be defined by a pair comprising an elevation, denoted h, and an azimuth, denoted A. The method also comprises a step of polarizing the collected beam 8 by selecting a direction of polarization of the collected beam 8 for each value of an angle θ(t) formed between an axis of polarization of a variable angle polarizer 4 and a reference direction 6. The angle θ(t) varies over time t. For the purposes of simplification of the description, the speed of variation of the angle θ(t) is constant over time. The polarization step is carried out by means of a polarizer 4. For each value of the angle θ(t), a given direction of polarization of the collected beam 8 is filtered. The reference direction 6 is defined with respect to the polarizer 4 but it can be defined with respect to the direction of the atmosphere (h, A). The filtered direction of polarization varies over time. The method comprises a step of selecting at least one frequency range of the collected beam 8. The selection step can consist of filtering the collected beam 8 and/or dispersing the collected beam 8. The selection step is implemented by means of an optical element 9 arranged to filter or disperse light. A frequency range of the collected beam 8 is chosen so that it comprises at least one RUA. The method then comprises measuring an intensity of the at least one frequency range of the collected and polarized, as a function of the angle θ(t), beam (I(θ,t)) 8. The measurement step is implemented by an optical detector 10. By way of non-limitative example, the sampling rate of the measurements is 1 kHz. The method comprises the step of determining at least one physical and/or chemical and/or electromagnetic parameter of the upper atmosphere, and/or a variation of at least one physical and/or chemical and/or electromagnetic parameter of the upper atmosphere, from values of I(θ,t) collected on a rotation of at least π/2 radians of the variable angle polarizer 4. Alternatively or together, the step of determination according to the method comprises determining a probability of malfunction and/or degradation of networks and/or installations and/or systems and/or electrical and/or electronic devices. The step of determination is implemented by a processing unit (not shown). Variation of a physical and/or chemical and/or electromagnetic parameter of the upper atmosphere is produced, among others, by a perturbation of the Earth's space environment. By way of non-limitative example, by “networks, installations, systems, electrical and/or electronic devices” is meant satellite telecommunications, terrestrial radio telecommunications, electrical grids and/or underground guidance devices.

The method makes it possible to analyse a given altitude range of the UA by selecting a frequency range of the collected beam 8 comprising a given RUA emitted by a given chemical element and/or molecule. A given emission of a given chemical element and/or molecule takes place at a given altitude of the UA. By way of non-limitative example, the chemical element and/or molecule of the UA emitting one or more polarized ray(s) comprise an emission of oxygen in the singlet state S (O^{1S}→O^{1D})at a wavelength of 557.7 nm and emitted at an altitude of approximately 110 km, an emission of oxygen in the singlet state D (O^{1D}→O^{3P}) at a wavelength of 630 nm and emitted at an altitude of approximately 220 km, an emission of the N₂⁺ cation at a wavelength of 391.4 nm and emitted at an altitude of between 85 and 90 km, an emission of the N₂⁺ cation at a wavelength of 427.8 nm and emitted at an altitude of between 85 and 90 km, these two emissions being due to the transition

N₂⁺ (B² Σᵤ⁺→x² Σ_{g}⁺). [Math 1]

FIG. 1 illustrates the principle of analysis of RUA. It is shown therein that the collected beam comprises a set of RUAs emitted in the UA. The electrons entering the UA and precipitating along the magnetic field lines are also shown therein. These electrons originate from the passage of the chemical elements and/or molecules into an excited state which will then relax to a more stable state, emitting a specific discrete radiation. This discrete radiation will generally be comprised between 1.10³ and 1.10⁷ GHz. Two principal sources of excitation can be at the origin of the emissions by the chemical elements and/or molecules. One of the sources is constituted by electrons created in the UA on the side of the planet exposed to the solar emissions by photo-ionization, these latter being capable of being derived from the side of the Earth not exposed to the solar emissions. and another of the sources is constituted by electrons originating from the magnetosphere, in particular from the tail current of the magnetosphere.

The at least one frequency range of the collected beam 8 selected during the selection step is comprised between 1.10³ and 1.10⁷ GHz. The measurement and determination steps are carried out successively to the selection step. The at least one frequency range of the collected beam 8 is arranged so as to comprise an RUA, for example, one of the RUAs described above. In practice, the selected frequency range of the collected beam 8 is centred on the chosen frequency of the RUA and extends over a range of wavelengths less than 15 nm, preferably less than 10 nm around the frequency of the chosen RUA.

The at least one determined physical and/or chemical and/or electromagnetic parameter of the upper atmosphere comprises an angle of polarization (AoLP) of a radiation emitted by the upper atmosphere in a manner polarized at a wavelength comprised within the selected frequency range of the collected beam 8, and/or a degree of polarization (DoLP), before collection, of the collected beam 8.

The particles present or travelling through the UA are also considered to be components of the UA. These are for example electrons, neutral or charged particles, ions, gas molecules. The ions and electrons constitute the ionosphere while the neutral gases constitute the thermosphere. The mixture of the ionosphere and the thermosphere constitutes the UA. The mixture of neutral particles and electrically charged particles constitutes what is called a plasma. The chemical elements and/or molecules of the UA are components of the UA.

The AoLP represents the relationship between the polarised portion of the collected beam 8, i.e. Ie RUA, and the unpolarized portion of the collected beam 8. The inventors have demonstrated that the AoLP of the RUA provides information on the configuration of the external magnetic field and the DoLP provides information on the geomagnetic activity. These two parameters make it possible to analyse and monitor the UA. The AoLP can in particular be used to analyse the Earth's magnetic field and its variations, in particular those caused by solar activity.

The variation of at least one physical and/or chemical and/or electromagnetic parameter of the determined upper atmosphere comprises varying a concentration and/or a temperature and/or a composition and/or a velocity of at least one of the components of the upper atmosphere. Alternatively or together, the variation of at least one physical and/or chemical and/or electromagnetic parameter of the determined upper atmosphere comprises varying a value of the Earth's magnetic field and/or of an ionospheric current, and/or of a value of the electric field, and/or an angle of polarization (AoLP) of a radiation emitted by the upper atmosphere in a manner polarized at a wavelength comprised within the selected frequency range of the collected beam 8, and/or a degree of polarization (DoLP), before collection, of the collected beam 8.

The perturbation of the Earth's space environment comprises, among others, an intrinsic variation of the Earth's magnetic field and/or a solar storm.

Preferably, according to a first variant of the first embodiment, the determination step is carried out by using, over a time interval corresponding to a rotation of at least π/2 radians of the variable angle polarizer 4, I(θ,t) and the product of I(θ,t) multiplied by sine (2θ(t)) and/or cos(2θ(t)). The angle of rotation of the polarizer 4 θ(t) varies as a function of time. The polarizer 4 has a period of rotation T₀. The number of photons collected is in the following form:

[Math 2]

λₜ=λ₀/2+λcos² 2(θₜ−δ) (Equation 1),

where λ₀ and λ are respectively the unpolarized and polarized fractions of photons and θ and δ are angles formed between the reference direction 6 and respectively an axis of polarization of the variable angle polarizer 4 and the axis of polarization of the upper atmosphere radiation observed. The number of photons can be considered as a random variable that follows Poisson's law. When the number of photons detected is greater than several tens, the Poisson variable can be approximated by a Gaussian variable of the same mean and variance. The intensity measured at the output of the detector 10 can therefore be considered as a Gaussian process Iₜ equal to:

[Math.3]

Iₜ=A+B cos(2θₜ+2δ)+\sqrt{A+B cos(2θₜ+2δ)} wₜ (Equation 2),

where A=(λ₀+λ)/2, B=λ/2 and wₜ is a Gaussian process having a zero mean and a constant variance depending on the quantum efficiency and the pass band of the detection system. The inventors verified that the correlation time is significantly smaller than the period T₀. This makes it possible to consider wₜ as a Gaussian white noise. Therefore, the DoPL corresponds to the ratio λ/(λ+λ₀) or to B/A and AoPL corresponds to δ.

In order to reach the information modulated in the sinusoidal signal Iₜ, the signal Iₜ must be multiplied by a similar periodic signal and the product averaged over at least one period. As the model comprises two variables, this processing must be carried out twice with two orthogonal periodic signals. For each given rotation i, with angle value θ(t), or θₜ in equations 1 and 2, greater than or equal to π/2:

$$\begin{matrix}[ Math 4 ] & \\ {x}_{i} = \frac{1}{{T}_{0}} {\int }_{0}^{{T}_{0}} {I}_{t} cos 2 {θ}_{t} dt , with 2 δ = arccos ( {x}_{i} / λ ) , & ( Equation 3 ) \\ [ Math 5 ] & \\ {y}_{i} = \frac{1}{{T}_{0}} {\int }_{0}^{{T}_{0}} {I}_{t} sin 2 {θ}_{t} dt , with B = \sqrt{{x}_{i}^{2} + {y}_{i}^{2}} , & ( Equation 4 ) \\ [ Math 6 ] & \\ {z}_{i} = \frac{1}{{T}_{0}} {\int }_{0}^{{T}_{0}} {I}_{t} dt , with A = {z}_{i} , \\ with 2 δ = arccos ( {x}_{i} / λ ) , B = \sqrt{( {x}_{i}^{2} + {y}_{i}^{2} )} and A = {z}_{i} . & ( Equation 5 )\end{matrix}$$

According to a second variant of the first embodiment, not exclusive of the first variant, the determination step is carried out by calculating a relationship between an intensity, at twice a frequency of rotation of the polarizer, of a Fourier transform of I(θ,t), and an intensity, at zero frequency, of a Fourier transform of the at least one frequency range of an unpolarized collected beam 8 originating from the direction (h, A) of the atmosphere.

According to an improvement of the second variant of the first embodiment, the polarized collected beam 8 and the unpolarized collected beam originate from two beams 8 collected differently. In this case, the unpolarized collected beam and the polarized collected beam 8 preferably originate from the same direction (h, A) of the atmosphere. Preferably, the determination step comprises a low pass filter which is applied to the signal I(θ,t). The central frequency depends on the speed of variation of the angle θ(t) and is chosen so that I(θ,t) has two maxima and two minima. Therefore, the power spectral density of the signal I(θ,t) has a maximum in the region of a frequency corresponding to twice the frequency of rotation. An inverse Fourier transform is then applied to the filtered signal I(θ,t).

It is noted directly and unambiguously that the step of determination according to the first and third variants is carried out only from the signal I(θ,t).

It is noted directly and unambiguously that the step of determination according to the first and third variants is carried out without using an unpolarized collected beam 8 originating from the direction (h, A) of the atmosphere. In other words, the step of determination according to the first and third variants is not carried out from an unpolarized collected beam 8 originating from the direction (h, A) of the atmosphere, but is carried out only from the signal I(θ,t).

By the term “only” is meant data, or the signal constituted thereby, from which the determination is carried out. The expression “only from” therefore relates to the signal from which the determination is carried out. The term “only” does not exclude the physical, chemical or mathematical parameters that may be used during the determination, i.e. during the processing of the signal of I(θ,t). For example, the signal can be processed, corrected or modified (for example by means of a product, a transform or a convolution, etc), prior to or concomitantly with the processing step, by using for example physical or chemical parameters such as for example temperature, pressure or dimensionless quantities (such as correction factors).

It is noted on the other hand, directly and unambiguously that the step of determination according to the second variant is carried out from the signal I(θ,t) and from an unpolarized collected beam 8.

According to a third variant of the first embodiment, not exclusive of the first and second variants, the determination step is carried out by implementing the steps consisting of applying a band-pass filter to I(θ,t) and adjusting the filtered value of I(θ,t) by a cos². In practice, an adjustment to the value of the filtered signal is made with a cos². Therefore, the DoPL corresponds to the ratio λ/(λ+λ₀) and the phase of the cos² originating from the adjustment corresponds to the AoLP.

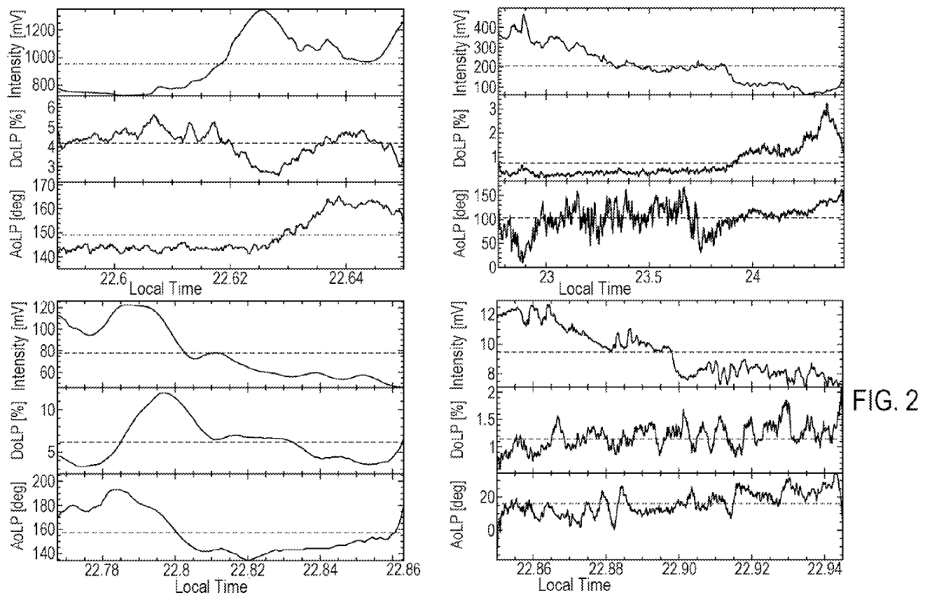

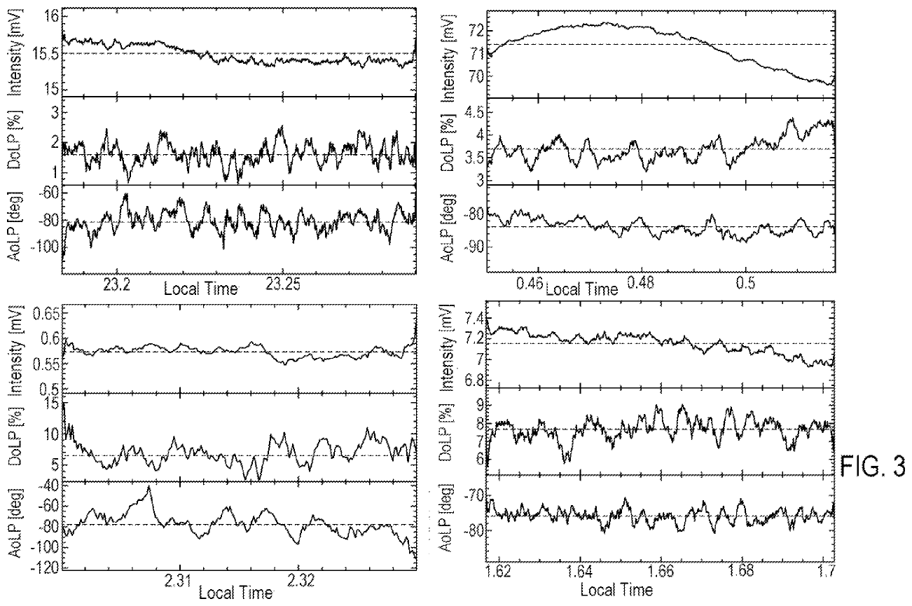

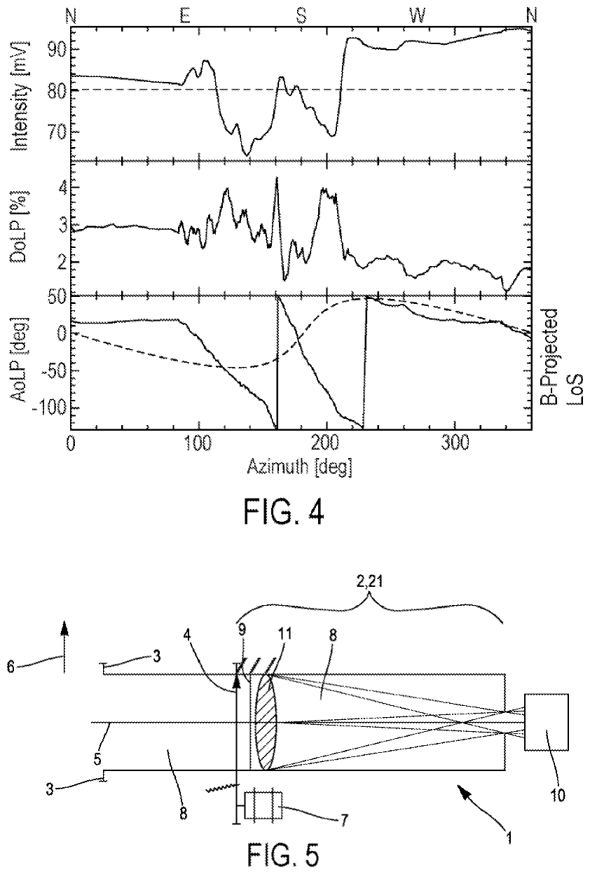

FIGS. 2 and 3 show four sets each constituted by three curves, each set relating to a different RUA, and FIG. 4 shows a set of three curves relating to one and the same RUA. Each set comprises 3 separate superimposed curves; the topmost curve represents the intensity I(θ,t) in arbitrary units, measured as a function of the local time in hours expressed in decimal units, the middle curve shows the DoLP, expressed as a percentage of the total intensity, determined from I(θ,t) and drawn as a function of the local time in hours expressed in decimal units and the bottom curve shows the AoLP, the value of the polarization angle is expressed in degrees, determined from I(θ,t) and drawn as a function of the local time in hours expressed in decimal units. The curves for AoLP and DoLP shown in FIGS. 2, 3 and 4 were determined according to the first variant of the determination step. With reference to FIG. 4, the three curves originate from measurements carried out on the RUA corresponding to the green emission line of atomic oxygen at 577.7 nm. With reference to FIGS. 2 and 3, the set of curves at the top left relate to measurements carried out on the RUA corresponding to the red emission line of atomic oxygen at 630 nm; the set of curves at the top right relates to the measurements carried out on the RUA corresponding to the green emission line of atomic oxygen at 577.7 nm, the set of curves at the bottom left relates to the measurements carried out on the RUA corresponding to the purple emission line of the nitrogen cation at 391.4 nm and the set of curves at the bottom right relates to the measurements carried out on the RUA corresponding to the blue emission line of the nitrogen cation at 427.8 nm. In FIGS. 2 and 3, the dashed lines indicate the average value of the magnitude determined over the observation period.

FIG. 2 shows four sets of measurements carried out in the auroral region at coordinates (69°23′27″N, 20°16′02″E) during an aurora borealis. The direction of the atmosphere according to which the beam is collected, and therefore from which the RUAs originate, is defined by an elevation of 30° with respect to the horizon and an azimuth equal to 270°. With reference to FIG. 2, the anti-correlation between the DoLP and the intensity of I(θ,t) demonstrates the observation of a magnetic phenomenon. The collisions between the high-energy electrons (several hundreds to several tens of thousands of electronvolts) of the solar rains and the chemical elements and/or molecules constituting the UA produce a depolarization of the emissions. The consequent rapid variations of intensity over time are characteristic of the phenomena linked to the polar rains; the energetic electrons constantly precipitate in the UA and result in permanent polarization of the emissions.

FIG. 3 shows four sets of measurements carried out at mid-latitude at coordinates (44°83′N, 5°76′E). The direction of the atmosphere according to which the beam is collected, and therefore from which the RUAs originate, is defined by an elevation of 45° with respect to the horizon and an azimuth equal to 270°. Unlike the measurements presented in FIG. 2, FIG. 3 shows measurements carried out at mid-latitude in the absence of auroral phenomena. Under these conditions, on the side of Earth exposed to the sun, the Earth's external magnetic field is constantly disturbed by perpendicular electric currents flowing from the side of Earth exposed to the sun and by variations of the local electric field produced, among others, by the tail current of the magnetosphere. In fact, the inventors have deduced from FIG. 3 that the electrons originating from the solar winds precipitate along magnetic field lines and excite the chemical elements and/or molecules of the UA in a direction that is, on average, parallel to the magnetic field lines. Therefore, the determined DoLP, called observed DoLP_{obs}, is equal to:

$$\begin{matrix}[ Math 7 ] & \\ {DoLP}_{obs} = \frac{{DoLP}_{actual}}{sin ɛ} , & ( Equation 6 )\end{matrix}$$

where DoLP_{actual} is the actual DoLP and ε is the angle between the direction of the atmosphere according to which the beam is collected and the local magnetic field line. Therefore the DoLP_{obs} corresponds to the projection of the DoLP_{actual} on the direction of the atmosphere according to which the beam is collected.

FIG. 4 shows the effect of the azimuth on the polarization of the RUA emitted at 577.7 nm. The direction of the atmosphere according to which the beam is collected is modified by carrying out a rotation of the azimuth by 2π in a time interval of four minutes extending from the North eastwards then from the South westwards. The solid line curves were determined for each rotation of 30π of the angle θ(t). The dash-dotted curve represents the angle formed between the magnetic field line and the direction of the atmosphere (45, 270) according to which the beam is collected. Unlike the auroral phenomena, the source of the excitations of the chemical elements and/or molecules constituting the UA are low-energy electrons, called “thermalized”, the energies of which are typically less than ten electronvolts, and most frequently of the order of one electronvolt. With reference to the curve at the bottom of FIG. 4, the AoLP and the theoretical angle of the magnetic field are considerably different in the portion of the curve corresponding to the South direction (approximately 180° on the axis of the curve). The AoLP and the theoretical angle of the magnetic field are extremely close in the one corresponding to the direction extending from North-West to North-East (90 to 270° on the axis of the curve) and decrease according to the same slope. According to the inventors, a storm system further South during the experiment could explain this observation. They deduce therefrom that the method makes it possible to follow the variations of the magnetic field in a calm sky and the variations of the electric field during sequences with strong electric fields.

Although at this stage of development of this new method, the AoLP and the DoLP are used as main parameters for analysis of the RUAs, a set of different parameters can also be deduced directly from (I(θ,t)). Alternatively or together, the at least one determined physical and/or chemical and/or electromagnetic parameter of the upper atmosphere comprises a concentration and/or a temperature and/or a composition and/or a velocity of at least one of the components of the upper atmosphere, and/or a value of the Earth's magnetic field and/or an ionospheric current, and/or an angle of polarization (AoLP) of a radiation emitted by the upper atmosphere in a manner polarized at a wavelength comprised within the selected frequency range of the collected beam 8, and/or a degree of polarization (DoLP), before collection, of the collected beam 8. The electric field is a local electric field in the region of the atmosphere analysed. Similarly, the value of the determined Earth's magnetic field is a local value adopted by the magnetic field in the region of the atmosphere analysed.

Similarly, alternatively or together, the variation of the at least one physical and/or chemical and/or electromagnetic parameter of the determined upper atmosphere comprises a variation of a concentration and/or a temperature and/or a composition and/or a velocity of at least one of the components of the upper atmosphere and/or of a value of the Earth's magnetic field, and/or an ionospheric current, and/or a value of the electric field. The perturbation of the Earth's space environment comprises, among others, an intrinsic variation of the Earth's magnetic field and/or a solar storm.

By way of non-limitative example, the value of the magnetic field and/or of the electric field is determined by carrying out prior calibration of the device for analysis of RUA. The sample used can be the intensity signal (I(θ,t)) and/or the AoLP and/or the DoLP. The value of the magnetic field and/or of the electric field and/or of the ionospheric current can also be deduced from the signal (I(θ,t)) and/or the AoLP and/or the DoLP by using, among others, the relationship

∇H=J_{c} [Math 8]

where H is the magnetic excitation and J_{c} the current density, and/or from Maxwell equations and/or by resolving the Boltzmann kinetic transport equation describing the collisions between energetic particles and the thermalized targets and allowing theoretical modelling of the polarization observed. Coordinated observations with for example SuperDarn radars with wide spatial coverage which measure the Earth's electric field, can make it possible to constrain the Maxwell equations and by measuring polarization parameters, deduce therefrom the magnetic field and/or the UA currents. Coordinated measurements with incoherent scatter radars will make it possible to deduce the ionospheric parameters (electronic and ionic concentration, electronic and ionic temperatures, ionic velocity) in order to constrain the models of transport and collision of particles, allowing modelling of the polarization. Taking account of the magnetometer networks that measure the integrated magnetic field from the ground will make it possible to characterize the local effects (by altitude) and global effects on the magnetic field variations.

The probability of malfunction and/or degradation is determined from one or more physical and/or chemical and/or electromagnetic parameter(s) of the determined UA. Preferably, the probability of malfunction and/or degradation is determined from the variation of at least one physical and/or chemical and/or electromagnetic parameter of the determined upper atmosphere. By way of non-limitative example, the determination of the variation over time and space of (I(θ,t)) is used to forecast the areas of the Earth's space environment and/or the areas of the Earth's surface and/or the underground areas in which a malfunction and/or a degradation is to be expected. As a function of previously defined amplitudes of threshold variations of at least one physical and/or chemical and/or electromagnetic parameter of the determined upper atmosphere, the degree of impact of the phenomena and/or perturbations, ranging from simple temporary malfunction to irreversible damage to equipment, will be determined.

One or more step(s) of the method are implemented, concomitantly or successively for several frequency ranges of the collected beam 8. The one or more step(s) of the method that are implemented, concomitantly or successively, for several frequency ranges of the collected beam 8 are preferably, among others, the selection and determination steps. This aspect of the method allows the analysis of several RUAs originating from several emissions and/or from several directions of the atmosphere.

The selection and determination steps are implemented, concomitantly or successively, for several frequency ranges of the collected beam 8, or collected beams 8, each of the selected frequency ranges being different from another of the selected frequency ranges. This aspect of the method allows the analysis of several RUAs originating from different emissions and therefore from several altitudes of the UA.

The collection and determination steps are implemented, concomitantly or successively, for several collected beams 8 originating from different directions of the atmosphere.

With reference to FIGS. 5, 6, 7 and 8 according to a second aspect of the invention, a device 1 is proposed for analysing radiation emitted by the upper atmosphere. This device is arranged in order to implement the method according to the first aspect of the invention. Thus, any characteristic of the method according to the first aspect of the invention can be implemented by the corresponding characteristic of the device 1. Thus, any characteristic of the method according to the first aspect of the invention can be associated and/or incorporated with the corresponding characteristic of the device 1 according to the second aspect of the invention. The device 1 according to the second aspect of the invention comprises at least one detection path 2. A detection path is shown in FIG. 5. The detection path 2 comprises the collector 3 arranged for collecting a beam originating from a given direction of the atmosphere (h, A). The collector 3, the lens 11 and the surface of the detector 10 are arranged to collect a beam 8 originating from the atmosphere with a solid angle of approximately 2°. The device 1 comprises the variable angle polarizer 4 arranged for selecting a direction of polarization of the collected beam 8 for each value of an angle θ(t) formed between the axis of polarization of the variable angle polarizer 4 and a reference direction 6, the angle θ(t) varying over time t. By way of example, the device uses a polarizer filter made by Hoya, type HRT CIR-PL UV. For the purposes of simplification of the description, the speed of rotation of the variable angle polarizer 4 is constant over time. According to the embodiment, the variable angle polarizer 4 is a rotary polarizer 4 rotated by a motor 7. The device comprises the optical element 9 arranged for selecting at least one frequency range of the collected beam 8. In practice, the optical element 9 is arranged to select the at least one frequency range of the collected beam 8 within a range of frequencies comprised between 1.10³ and 1.10⁷ GHz.

According to the embodiment, the optical element 9 is an optical filter 9 arranged for selecting a frequency range. By way of example, the device uses filters made by Omega Optical. The red filter is a 3056943 630 NB1, having a bandwidth of 2 nm. The other coloured filters are made by Edmund Optics, type CWL. They have a bandwidth of 10 nm or 25 nm, as the wavelengths observed are well isolated in the spectrum of the UA. The central wavelengths are 390 nm (violet N₂⁺), 430 nm (blue N₂⁺) and 560 nm (green O). The device 1 comprises a photo-detector 10 arranged for measuring the intensity of the at least one frequency range of the collected and polarized, as a function of the angle θ(t), beam 8 (I(θ,t)). By way of example, the device 1 uses a photo-detector made by Hamamatsu, type H7422-40 for the high sensitivities (use in mid-latitude for example) and type H10721-20 for a wide dynamic range and a greater number of photons requiring a lower sensitivity (for auroral conditions for example).

According to the embodiment, the device 1 comprises a lens 11 arranged to focus the collected beam 8 on the photo-detector 10. By way of example, the device 1 uses a lens made by Opto-Sigma, type SLB 08B. The optical axis 5 of the device 1 is merged with the axis of rotation 5 of the rotary polarizer 4 as well as with the optical axis of the lens 11. The device 1 comprises a processing unit (not shown) arranged and/or configured and/or programmed to determine, from the I(θ,t) values collected over a rotation of at least π/2 radians of the variable angle polarizer 4, the at least one physical and/or chemical and/or electromagnetic parameter, and/or a variation of at least one physical and/or chemical and/or electromagnetic parameter of the upper atmosphere. Alternatively or together, the processing unit is arranged and/or configured and/or programmed to determine, from values of I(θ,t) collected over a rotation of at least π/2 radians of the variable angle polarizer 4, the at least one probability of malfunction and/or degradation of networks and/or installations and/or systems and/or electrical and/or electronic devices. By “processing unit” is meant a computer, a calculation and/or central processing unit, an analogue electronic circuit (preferably dedicated), a digital electronic circuit (preferably dedicated), and/or a microprocessor (preferably dedicated), and/or software means.

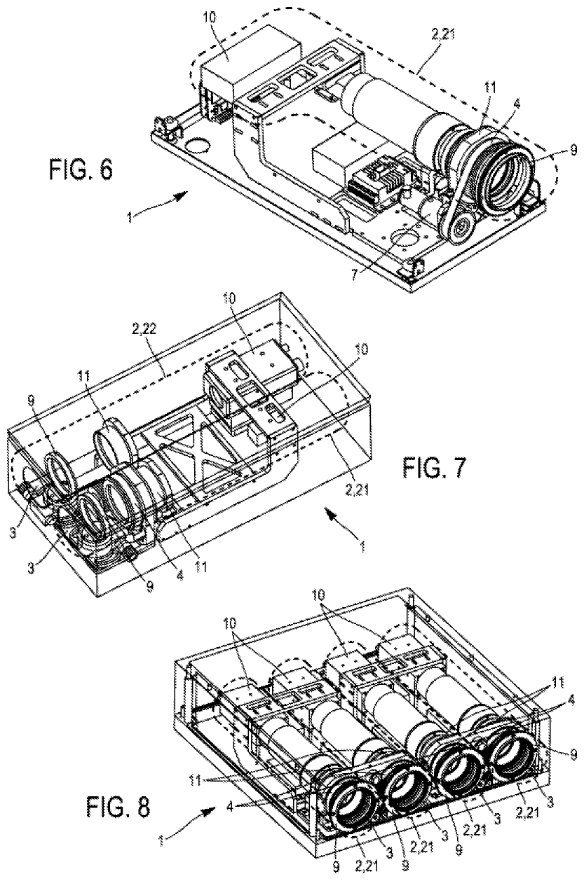

Preferably, according to a first variant of the second embodiment and with reference to FIG. 6, the processing unit is arranged and/or configured and/or programmed to determine the at least one parameter and/or the variation of at least one parameter and/or the probability of malfunction and/or degradation by using, over a time interval corresponding to a rotation of at least π/2 radians of the variable angle polarizer, I(θ,t) and the product of I(θ,t) multiplied by sine (2θ(t)) and/or cos(2θ(t)). In this case, the device 1 comprises a single detection path 2, as shown in FIG. 6, or several detection paths 2, as shown in FIG. 8. A detection path 2 comprises, as a minimum, un variable angle polarizer 4.

According to a second variant of the second embodiment, not exclusive of the first variant, the processing unit is arranged and/or configured and/or programmed to determine the at least one parameter and/or the variation of at least one parameter and/or the probability of malfunction and/or degradation by implementing the steps consisting of applying a band-pass filter to I(θ,t) and adjusting the filtered value of I(θ,t) by a cos². In this case, the device 1 comprises a single detection path 2, as shown in FIG. 6, or several detection paths 2. A detection path 2 comprises, as a minimum, un variable angle polarizer 4. Preferably, the device 1 comprises a single detection path 2, as shown in FIG. 6, or several detection paths 2, as shown in FIG. 8. A detection path 2 comprises, as a minimum, un variable angle polarizer 4.

According to a third variant of the second embodiment, the processing unit is arranged and/or configured and/or programmed to determine the at least one parameter and/or the variation of at least one parameter and/or the probability of malfunction and/or degradation by calculating a relationship between an intensity, at twice the frequency of rotation of the polarizer, of the Fourier transform of I(θ,t), and an intensity, at zero frequency, of a Fourier transform of the at least one range of frequencies of an unpolarized collected beam 8 originating from the direction (h, A) of the atmosphere. In this case, the device 1 comprises a single detection path 2, as shown in FIG. 7, or several detection paths 2.

According to the third variant, the device 1 can comprise, as shown in FIG. 7, two detection paths 2, 21, 22 or more. One of the detection paths 2, 22, called reference detection path, is arranged to collect a beam originating from the same direction (h, A) of the atmosphere as the other detection path 2, 21, called measurement detection path. The beam collected by the reference path 22 comprises an optical filter 9 arranged to select one and the same frequency range identical to the frequency range selected by the optical filter 9 of the measurement path 21.

According to the third variant, the device 1 can comprise one or respectively several measurement paths 2, 21, as shown respectively in FIGS. 6 and 8. In this case, the processing unit is arranged and/or configured and/or programmed to determine the at least one parameter and/or the variation of at least one parameter and/or the probability of malfunction and/or degradation by calculating a relationship between the intensity, at twice the frequency of rotation of the polarizer, of the Fourier transform of I(θ,t), and the intensity, at zero frequency, of the Fourier transform of I(θ,t).

Preferably, the processing unit is arranged and/or configured and/or programmed to determine the at least one parameter and/or the variation of the at least one parameter and/or of the probability of malfunction and/or degradation from the at least one parameter and/or from the variation of at least one parameter.

Any characteristic of the device according to the second aspect of the invention can be associated and/or incorporated with any corresponding characteristic of the method according to the first aspect of the invention.

Of course, the invention is not limited to the examples that have just been described, and numerous modifications may be made to these examples without exceeding the scope of the invention.

Thus, in the variants of the above-described embodiments that can be combined together:
according to the first embodiment, the method is implemented successively or concomitantly for several collected beams 8, and/or
according to the first embodiment, the speed of variation of the angle θ(t) during the polarization step is variable over time, and/or
the at least one selected frequency range of the collected beam can be different from at least one other selected frequency range of the collected beam, or of another collected beam, and/or
preferably, when the method is implemented for several collected beams 8, the speed of variation of the angle θ(t) during the step of polarization of a collected beam 8 is different from the speeds of variation of the angles θ(t) during the step or steps of polarization of the other collected beams 8, and/or
preferably, when the method is implemented for several collected beams 8, the method comprises a step of phase shift applied to the collected beams 8, the phase shift of one collected beam 8 being different to the phase shifts of the other collected beams 8, and/or
according to the first embodiment, the method comprises a step of compensation of the at least one frequency range of the collected beam 8 selected by modulation of an angle φ formed between a direction of propagation of the collected beam 8 and an optical element 9 used for the step of selecting the at least one frequency range of the collected beam 8, and/or
the at least one frequency range of the collected beam 8 is arranged so as to comprise several RUAs, and/or
the polarized collected beam 8 and the unpolarized collected beam constitute the collected beam 8, and/or
a portion of the collected beam 8 is polarized, and constitutes the polarized collected beam, and another portion of the collected beam 8 is for its part, not polarized, and constitutes the unpolarized collected beam, and/or
the selected frequency range of the collected beam 8 extends over a range of wavelengths less than 8 nm, preferably less than 6 nm, preferably less than 5 nm, and/or
the speed of variation of the angle θ(t) adopts a value of zero at a given moment, and/or
the variation of the angle θ(t) over time is discontinuous, and/or
according to the second embodiment, the optical element 9 is arranged for selecting several frequency ranges of the collected beam 8, and/or
the photo-detector 10 is of the single-pixel or pixel array type, and/or
the optical element 9 is arranged to disperse light, and/or
the optical element 9 is a prism or a diffraction grating, and/or
according to the third variant of the second embodiment, the device 1 comprises a single detection path 2, and/or
the speed of rotation of the variable angle polarizer 4 is variable over time, and/or
according to the second variant of the second embodiment, the speed of rotation of the variable angle polarizer 4 is preferably variable, and/or
more preferably, according to the second variant of the second embodiment, the speed of rotation of the variable angle polarizer 4 intermittently adopts a value of zero, so that the rotation is discontinuous, and/or
the optical element 9 is arranged so that an angle φ formed between a direction of propagation of the collected beam 8 in the detection path 2 and the optical element 9 is capable of being modulated so as to modify the at least one frequency range of the collected beam 8 selected by the optical element 9, and/or
the device 1 comprises a single detection path 2, the single path comprising a variable angle polarizer and an optical element, and/or
the device 1 comprises a single detection path 2, the single path comprising a collector, a variable angle polarizer and an optical element, and/or
the device 1 comprises several detection paths 2; each of the paths from the several detection paths comprises a variable angle polarizer and an optical element, and/or
the device 1 comprises several detection paths 2; each of the paths from the several detection paths comprises a collector, a variable angle polarizer and an optical element, and/or
the device 1 comprises several detection paths 2 and:
   each of the detection paths 2 comprises an optical element 9 as described above, and/or
   a detection path 2 is arranged for collecting a beam originating from a direction of the atmosphere different from:
a direction of the atmosphere from which a beam 8 collected by another detection path 2 originates, or
directions of the atmosphere from which beams 8 collected by other detection paths 2 originate, or
all of the directions of the atmosphere from which the beams 8 collected by the other detection paths 2 originate.
when the device 1 comprises several detection paths 2, the collector 3 and/or the photo-detector 10 and/or the variable angle polarizer 4 and/or the optical element 9 are common to all the paths 2, and/or
preferably, when the photo-detector 10 is common to all the paths 2, each of the paths 2 comprises a variable angle polarizer 4, and/or
when the photo-detector 10 is common to all the paths 2, each of the paths 2 comprises an angle polarizer 4, each polarizer 4 having a different speed of rotation, and/or
when the photo-detector 10 is common to all the paths 2, a phase shift is applied to the collected beam 8 of each of the paths 2, the phase shift of one collected beam 8 being different from the phase shifts of the collected beams 8 of the other paths 2, and/or
when the device 1 comprises several detection paths 2 and a detection path 2 comprises only the variable angle polarizer 4, the optical element 9 of the device 1 common to all the paths 2 is a prism 9 or a diffraction grating 9, and/or
preferably, when the device 1 comprises several detection paths 2, an optical element 9 of a detection path 2 is arranged for selecting at least one frequency range of the collected beam 8 different from at least one other frequency range of the collected beam 8, or from another collected beam 8, the frequency range selected by an optical element 9 of another detection path 2, and/or
the device 1 comprises one or more mechanism(s) for movement arranged for modifying an orientation and/or an elevation:
   of a detection path 2, independently of an orientation and/or an elevation of another detection path 2, or
   of several detection paths 2 independently of an orientation and/or an elevation of one or more other detection path(s) 2, or
   of all of the detection paths 2 simultaneously, and/or
the device comprises one or more sensor(s) from a position sensor and/or a gyrometer and/or a compass.

In addition, the various characteristics, forms, variants and embodiments of the invention can be combined together in various combinations, to the extent that they are not incompatible or mutually exclusive.

1. A method for analysing radiation emitted by the upper atmosphere comprising the steps:
collecting a beam originating from a direction (h, A) of the atmosphere;
polarizing the collected beam by selecting a direction of polarization of the collected beam for each value of an angle θ(t) varying over time t, the angle θ(t) being formed between an axis of polarization of a variable angle polarizer and a reference direction,
selecting at least one frequency range of the collected beam;
measuring an intensity of the at least one frequency range of the collected and polarized, as a function of the angle θ(t), beam (I(θ,t)); and
determining, only from values of I(θ,t) collected over a rotation of at least π/2 radians of the variable angle polarizer:
at least one physical and/or chemical and/or electromagnetic parameter of the upper atmosphere, and/or a variation of at least one physical and/or chemical and/or electromagnetic parameter of the upper atmosphere; and/or
a probability of malfunction and/or degradation of networks and/or installations and/or systems and/or electrical and/or electronic devices.

2. The method according to claim 1, in which the at least one determined physical and/or chemical and/or electromagnetic parameter of the upper atmosphere comprises:
a concentration and/or a temperature and/or a composition and/or a velocity of at least one of the components of the upper atmosphere, and/or
a value of the Earth's magnetic field, and/or
an ionospheric current, and/or
a value of the electric field, and/or
an angle of polarization (AoLP) of a radiation emitted by the upper atmosphere in a manner polarized at a wavelength comprised within the selected frequency range of the collected beam, and/or
a degree of polarization (DoLP), before collection, of the collected beam.

3. The method according to claim 1, in which the variation of at least one physical and/or chemical and/or electromagnetic parameter of the determined upper atmosphere comprises a variation of:
a concentration and/or a temperature and/or a composition and/or a velocity of at least one of the components of the upper atmosphere, and/or
a value of the Earth's magnetic field, and/or
an ionospheric current, and/or
a value of the electric field, and/or
an angle of polarization (AoLP) of a radiation emitted by the upper atmosphere in a manner polarized at a wavelength comprised within the selected frequency range of the collected beam, and/or
a degree of polarization (DoLP), before collection, of the collected beam.

4. The method according to claim 1, in which the determination step is carried out:
by using, over a time interval corresponding to a rotation of at least π/2 radians of the variable angle polarizer, I(θ,t) and the product of I(θ,t) multiplied by sine (2θ(t)) and/or cos(2θ(t)), and/or
implementing the steps including:
applying a band-pass filter at I(θ,t),
adjusting the filtered value of I(θ,t) by a cos².

5. The method according to claim 1, in which the probability of malfunction and/or degradation is determined from the at least one determined physical and/or chemical and/or electromagnetic parameter of the upper atmosphere, and/or from the variation of at least one physical and/or chemical and/or electromagnetic parameter of the determined upper atmosphere.

6. The method according to claim 1, in which one or more step(s) of the method are implemented, concomitantly or successively for several frequency ranges of the collected beam.

7. The method according to claim 1, in which the selection and determination steps are implemented, concomitantly or successively, for several frequency ranges of the collected beam, or collected beams, each of the selected frequency ranges being different from another of the selected frequency ranges.

8. The method according to claim 1, in which the collection and determination steps are implemented, concomitantly or successively, for several collected beams originating from different directions of the atmosphere.

9. The method according to claim 1, in which the speed of variation of the angle θ(t) during the polarization step is variable over time.

10. The method according to claim 1, in which the at least one frequency range of the collected beam selected during the selection step is comprised between 1.103 and 1.107 GHz.

11. The method according to claim, 1, comprising a step of compensation of the at least one frequency range of the collected beam, the frequency range being selected by modulation of an angle φ formed between a direction of propagation of the collected beam and an optical element used for the step of selecting the at least one frequency range of the collected beam.

12. A device for analysing radiation emitted by the upper atmosphere comprising at least one detection path, said at least one detection path comprising:
a collector arranged for collecting a beam originating from a direction of the atmosphere (h, A);
a variable angle polarizer arranged for selecting a direction of polarization of the collected beam for each value of an angle θ(t) formed between an axis of polarization of the variable angle polarizer and a reference direction, the angle θ(t) varying over time t;
an optical element arranged for selecting at least one frequency range of the collected beam; and
a photo-detector arranged for measuring the intensity of the at least one frequency range of the collected and polarized, as a function of the angle θ(t), beam (I(θ,t));
said device comprising a processing unit arranged and/or configured and/or programmed to determine, from values of I(θ,t) collected over a rotation of at least π/2 radians of the variable angle polarizer:
at least one physical and/or chemical and/or electromagnetic parameter, and/or a variation of at least one physical and/or chemical and/or electromagnetic parameter of the upper atmosphere, and/or
a probability of malfunction and/or degradation of networks and/or installations and/or systems and/or electrical and/or electronic devices; and
the device comprises a single detection path or several detection paths, the single path or each of the paths from the several detection paths comprising a collector, a variable angle polarizer and an optical element.

13. The device according to claim 12, in which the polarizer is arranged to be rotated at a speed of rotation that is variable over time.

14. The device according to claim 12, in which the optical element is arranged to select the at least one frequency range of the collected beam within a range of frequencies comprised between 1.103 and 1.107 GHz.

15. The device according to claim 12, in which the optical element is arranged for selecting several frequency ranges of the collected beam.

16. The device according to claim 12, in which the optical element is arranged so that an angle φ formed between a direction of propagation of the collected beam in the path and the optical element is capable of being modulated so as to modify the at least one frequency range of the collected beam, the frequency range being selected by the optical element.

17. The device according to claim 12, comprising several detection paths and:
each of the detection paths comprises an optical element, and/or
a detection path is arranged for collecting a beam originating from a direction of the atmosphere different from:
a direction of the atmosphere from which a beam collected by another detection path originates, or
directions of the atmosphere from which beams collected by other detection paths originate, or
all of the directions of the atmosphere from which the beams collected by the other detection paths originate.
